(19) United States
(12) Patent Application Publication
(10) Pub. No.: US 2009/0262310 A1
(43) Pub. Date: Oct. 22, 2009

(54) PICTURE CORRECTION SYSTEMS AND METHODS

(75) Inventors: Chang-Jung Wen, Hsin-Chu (TW); Jung-Chi Chen, Hsin-Chu (TW); Chih-Hui Chang, Hsin-Chu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: CORETRONIC CORPORATION, Hsin-Chu (TW)

(21) Appl. No.: 12/400,094

(22) Filed: Mar. 9, 2009

(30) Foreign Application Priority Data
Apr. 22, 2008 (TW) 97114614

(51) Int. Cl. G03B 21/14

(52) U.S. Cl. 353/70

(57) ABSTRACT

A picture correction systems and a method are provided. The system includes a circular variable resistance unit and a control unit. The circular variable resistance unit includes at least two circular resistance coils and a control stick. One of the circular resistance coils receives a voltage. The control stick is disposed on the inner rims of the circular resistance coils to be electrically connected with the circular resistance coils. The control stick rolls along the inner rims of the circular resistance coils. The circular variable resistance unit generates a loop voltage according to a position of the control stick being located at the inner rims of the circular resistance coils. The control unit receives the loop voltage, and performs a picture correction for a projector according to the loop voltage.

### CROSS REFERENCE TO RELATED APPLICATIONS

This Application claims priority of Taiwan Patent Application No. 097114614, filed on Apr. 22, 2008, the entirety of which is incorporated by reference herein.

### BACKGROUND OF THE INVENTION

1. Field of the Invention

The disclosure relates generally to picture correction systems and methods, and, more particularly to systems and methods that automatically correct pictures for projection devices.

2. Description of the Related Art

With the development of technology, image projection devices, such as projectors have become important electronic devices for humans in work and life. For example, a projector is used for presentations during a meeting at work. Additionally, a projector is used as part of a home theater system, for playing movies at home.

Due to the various environments where the projection device may be used, the plane where the projection device may be placed or projected on may not be perpendicular, thus, a specific angle may exist therebetween. Therefore, the projected picture may be trapezoidal. Generally, a projector may provide a trapezoidal correction function to correct a trapezoidal picture, thus reducing the trapezoidal picture effect.

Conventionally, the trapezoidal correction function may be operated and set manually. Users may review the picture while they adjust the settings for trapezoidal correction, thus to obtain a desired picture. In some conventional practices, the projector may provide a function of automatic trapezoidal correction. Taiwan Patent Application No. 92118431 discloses a resistance value which may be determined according to the connectional relationship between a projector supporter and an adjustable component, and the trapezoidal correction is performed according to the resistance value. It is understood that, since the projector may not be placed on a horizontal plane, when the degree of the trapezoidal correction is only based on the length of the projector supporter, correction errors may occur. Additionally, since the projector supporter and the adjustable component physically contact with each other, the accuracy of trapezoidal correction may be reduced after the supporter has been adjusted a number of times.

Meanwhile, a projector usually provides several use modes, such as table and ceiling modes. For example, when the projector is placed on a table, users may manually set the use mode as the table mode via an operation interface of the projector. When the projector is hanged on a ceiling, users may manually set the use mode as the ceiling mode via the operation interface of the projector. As described, user may manually perform related operations and settings, thus, inconveniencing users.

### BRIEF SUMMARY OF THE INVENTION

Accordingly, the invention is to provide a picture correction system and a picture correction method that automatically correct pictures for projection devices.

An embodiment of a picture correction system of the invention includes a circular variable resistance unit and a control unit. The circular variable resistance unit includes at least two circular resistance coils and a control stick. One of the circular resistance coils receives a voltage. The control stick is disposed on the inner rims of the circular resistance coils to be electrically connected with the circular resistance coils. The control stick rolls along the inner rims of the circular resistance coils. The circular variable resistance unit generates a loop voltage according to a position of the control stick being located at the inner rims of the circular resistance coils. The control unit receives the loop voltage, and performs a picture correction for a projection device according to the loop voltage.

In an embodiment of a picture correction method for a projection device of the invention, a circular variable resistance unit is provided, wherein the circular variable resistance unit includes at least two circular resistance coils and a control stick. The control stick is disposed on the inner rims of the circular resistance coils to be electrically connected with the circular resistance coils. The control stick rolls along the inner rims of the circular resistance coils. Then, one of the circular resistance coils receives a voltage, and the circular variable resistance unit generates a loop voltage according to a position of the control stick being located at the inner rims of the circular resistance coils. Then, a picture correction is performed for the projection device according to the loop voltage.

Picture correction systems and methods for ballasts may take the form of a program code embodied in a tangible media. When the program code is loaded into and executed by a machine, the machine becomes an apparatus for practicing the disclosed method.

Therefore, the picture correction system and method of the embodiments of the invention may automatically correct pictures for projection devices. The use mode setting and/or the trapezoidal correction may be automatically achieved without any manual operation.

Other objectives, features and advantages of the present invention will be further understood from technological features disclosed by the embodiments of the present invention. Wherein the shown and described preferred embodiments of this invention, are simply illustrations of modes best suited to carry out the invention.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a picture correction system of the invention;

FIG. 2 is a schematic diagram illustrating an embodiment of a circular variable resistance unit of the invention;

FIG. 3A is a schematic diagram illustrating an embodiment of a projection situation for a projection device in a table mode of the invention;

FIG. 3B is a schematic diagram illustrating an embodiment of the circular variable resistance unit for the projection device in the table mode of the invention;

FIG. 3C is a schematic diagram illustrating an embodiment of a current loop for the projection device in the table mode of the invention;

FIG. 4A is a schematic diagram illustrating an embodiment of a projection situation for a projection device in a ceiling mode of the invention;

FIG. 4B is a schematic diagram illustrating an embodiment of the circular variable resistance unit for the projection device in the ceiling mode of the invention;

FIG. 4C is a schematic diagram illustrating an embodiment of a current loop for the projection device in the ceiling mode of the invention;

FIG. 5 is a flowchart of an embodiment of a picture correction method of the invention;

FIG. 6 is a flowchart of an embodiment of a method for setting use mode of the invention;

FIG. 7 is a schematic diagram illustrating an embodiment of a range distribution of the circular resistance coils for use mode determination of the invention;

FIG. 8 is a flowchart of an embodiment of a trapezoidal correction method of the invention; and

FIG. 9 is a flowchart of an embodiment of a picture correction method of the invention.

### DETAILED DESCRIPTION OF THE INVENTION

In the following detailed description of the preferred embodiments, reference is made to the accompanying drawings which form a part hereof, and in which shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

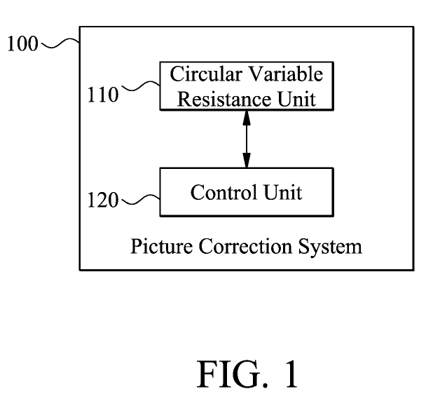

FIG. 1 is a schematic diagram illustrating an embodiment of a picture correction system of the invention.

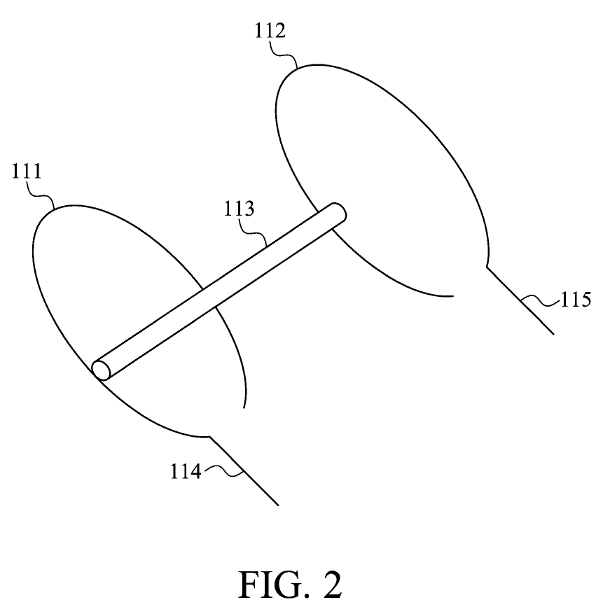

The picture correction system 100 in accordance with the embodiment of the invention is adapted to an image protection device, such as a projector. The picture correction system 100 includes at least a circular variable resistance unit 110 and a control unit 120. FIG. 2 is a schematic diagram illustrating an embodiment of a circular variable resistance unit 110 of the invention. As shown in FIG. 2, the circular variable resistance unit 110 includes at least two circular resistance coils 111 and 112, a control stick 113, and leads 114 and 115 respectively connected to the circular resistance coils 111 and 112. The circular resistance coils 111 and 112 are arranged parallel to each other substantially, and each of the circular resistance coils 111 and 112 has an open edge. The control stick 113 is disposed on the inner rims of the circular resistance coils 111 and 112 to be electrically connected with the circular resistance coils 111 and 112. The control stick 113 rolls along the inner rims of the circular resistance coils 111 and 112. In some embodiments, the circular resistance coils 111 and 112 may be connected to the control unit 120 via the leads 114 and 115, respectively. The control unit 120 can output a voltage to the circular resistance coil 112 of the circular variable resistance unit 110 via the lead 115, and receive a loop voltage generated by the circular variable resistance unit 110 via the control stick 113, the circular resistance coil 111, and the lead 114. The control unit 120 may perform a picture correction for the projection device according to the loop voltage.

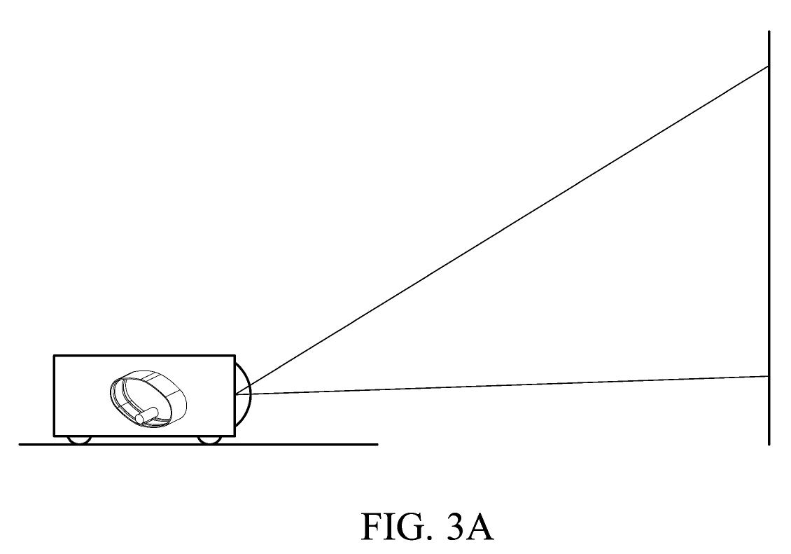

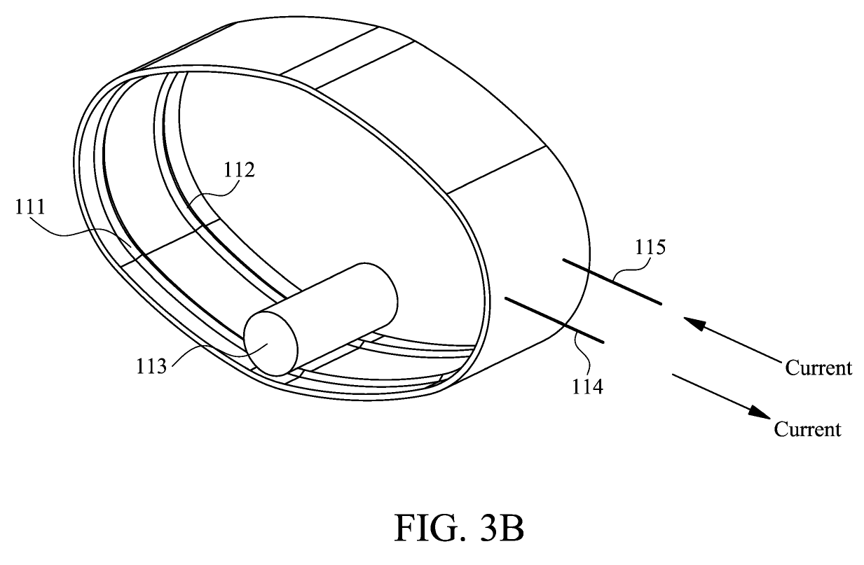

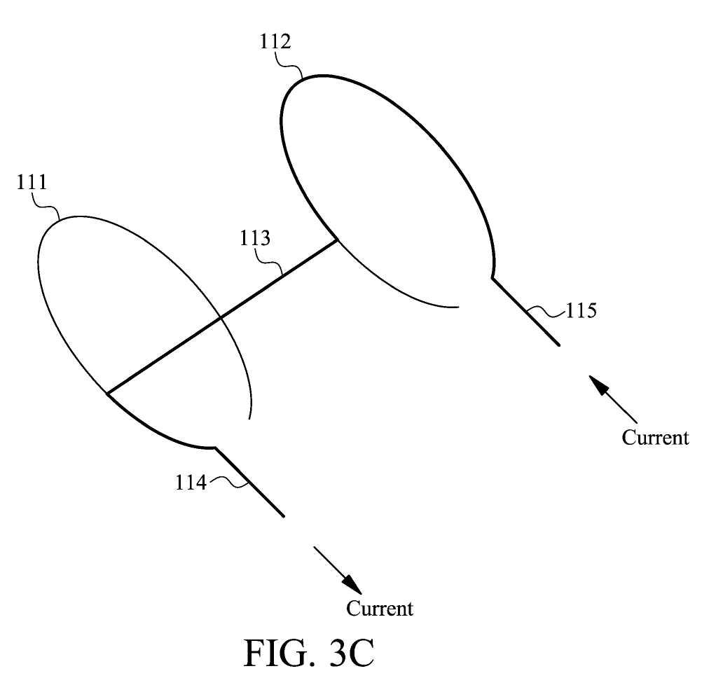

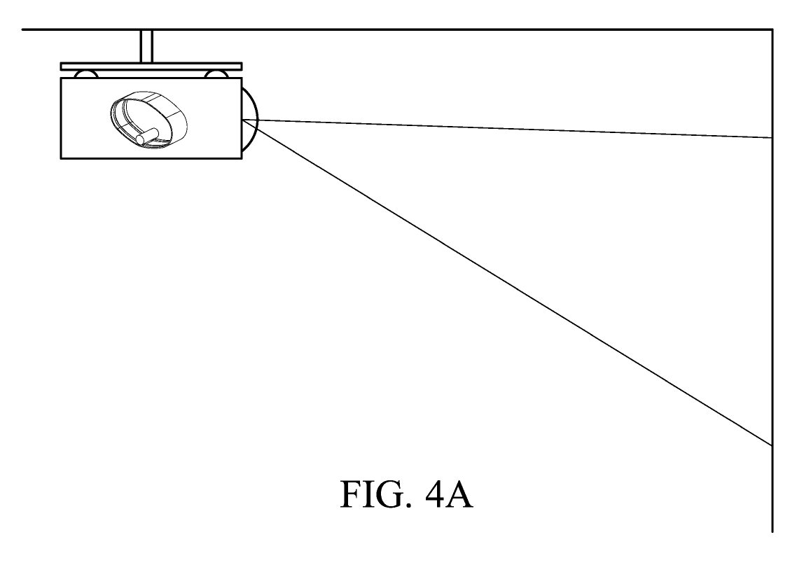

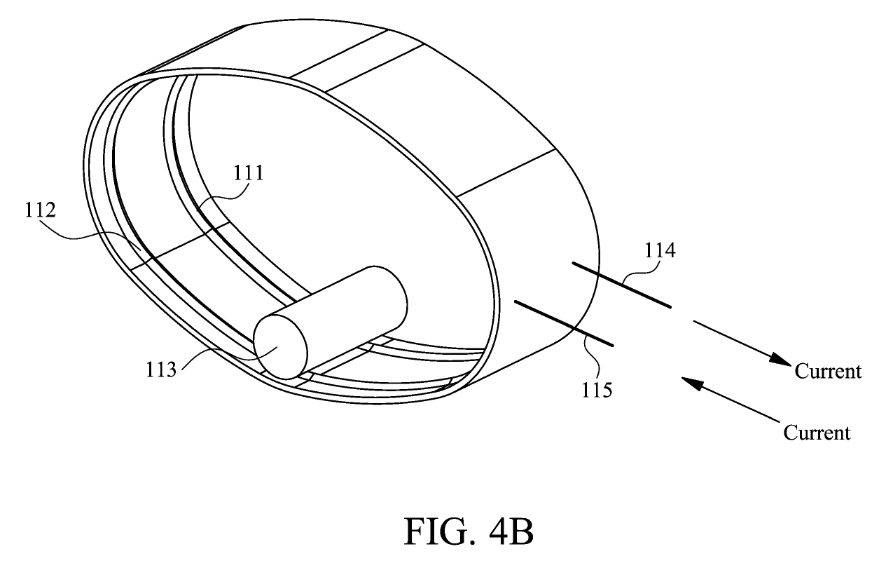

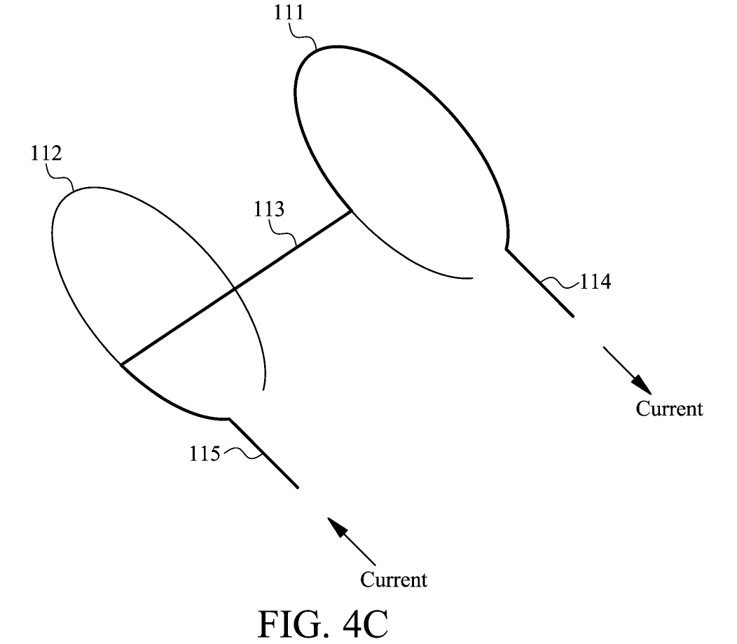

It is understood that, the position of the control stick 113 is changed according to disposition of the projection device. For example, when the projection device projects pictures in the table mode as shown in FIG. 3A, the circular variable resistance unit 110 is as shown in FIG. 3B, and the current loop generated by the circular resistance coils 111 and 112, and the control stick 113 in the circular variable resistance unit 110 is as shown in FIG. 3C. Additionally, when the projection device projects pictures in the ceiling mode as shown in FIG. 4A, the circular variable resistance unit 110 is as shown in FIG. 4B, and the current loop generated by the circular resistance coils 111 and 112, and the control stick 113 in the circular variable resistance unit 110 is as shown in FIG. 4C. It is noted that, loop lengths of current flowing through the circular resistance coils 111 and 112 are different according to different positions on the inner rims of the circular resistance coils 111 and 112 where the control stick 113 is located respectively, so that the circular variable resistance unit 110 generates different loop voltages.

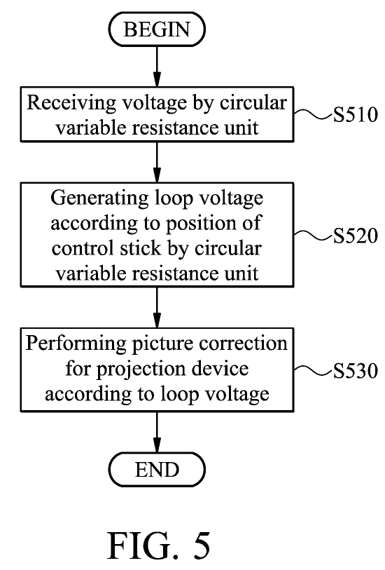

FIG. 5 is a flowchart of an embodiment of a picture correction method of the invention. The picture correction method in accordance with the embodiment of the invention is adapted to an image projection device, such as a projector. The projection device has a circular variable resistance unit. The circular variable resistance unit includes at least two circular resistance coils and a control stick. The control stick is disposed on the inner rims of the circular resistance coils to be electrically connected with the circular resistance coils. The control stick rolls along the inner rims of the circular resistance coils. The circular resistance coils and the control stick form a loop circuit.

In step S510, one of the circular resistance coils receives a voltage. In step S520, the circular variable resistance unit generates a loop voltage according to the position of the control stick being located at the inner rims of the circular resistance coils. Then, in step S530, a picture correction is performed for the projection device according to the loop voltage.

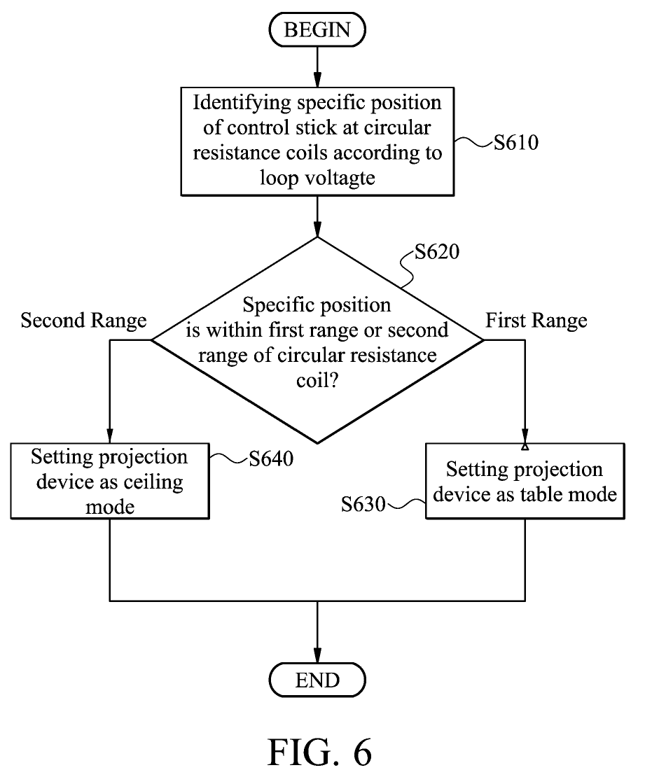

FIG. 6 is a flowchart of an embodiment of a method for setting use mode of the invention. In this embodiment, the picture correction is used to set the use mode for the projection device.

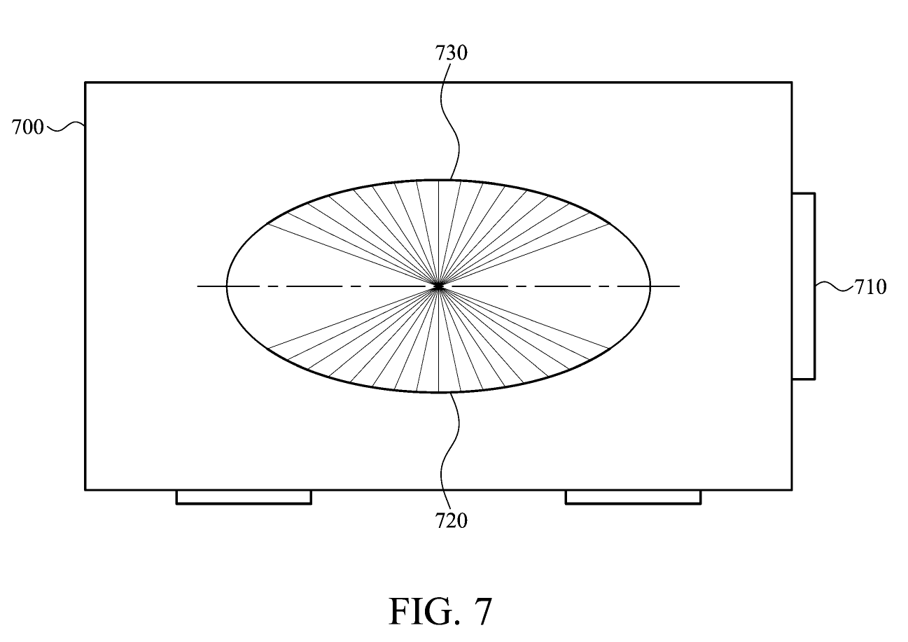

In step S610, a specific position of the control stick being located at the inner rims of the circular resistance coils is identified according to the loop voltage generated by the circular variable resistance unit. It is understood that, in some embodiments, the specific position of the control stick being located at the inner rims of the circular resistance coils may be obtained by searching a first mapping table according to the loop voltage. The first mapping table records the positions of the control stick being located at the inner rims of the circular resistance coils corresponding to different loop voltages. In step S620, it is determined whether the specific position of the control stick is within a first range or a second range of the inner rims of the circular resistance coils. The first range and the second range are not overlapped to each other. When the specific position of the control stick is within the first range of the inner rims of the circular resistance coils, in step S630, the use mode of the projection device is set as the table mode. When the specific position of the control stick is within the second range of the inner rims of the circular resistance coils, in step S640, the use mode of the projection device is set as the ceiling mode. An example follows. FIG. 7 is a schematic diagram illustrating an embodiment of a range distribution of the circular resistance coils for use mode determination of the invention. In FIG. 7, the circular resistance coils are in a projection device 700 having a lens 710. As shown in FIG. 7, when the position of the control stick is within the first range 720, the use mode of the projection device 700 is automatically set as the table mode. When the position of the control stick is within the second range 730, the use mode of the projection device 700 is automatically set as the ceiling mode. It is noted that, the coverage ranges of the first range 720 and the second range 730 may be adjusted according to various requirements.

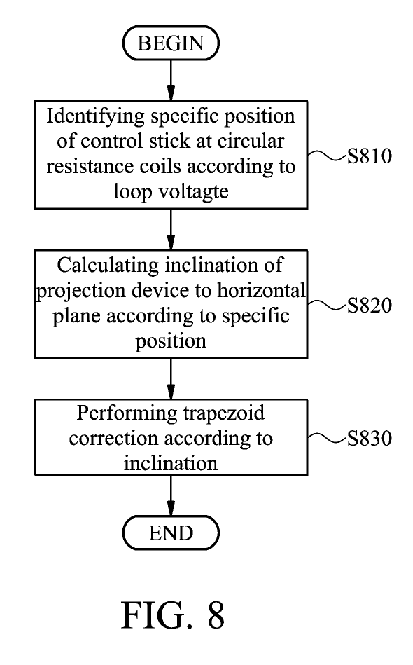

FIG. 8 is a flowchart of an embodiment of a trapezoidal correction method of the invention. In this embodiment, the control unit performs a trapezoidal correction for the projection device according to a specific position of the control stick.

In step S810, a specific position of the control stick being located at the inner rims of the circular resistance coils is identified according to the loop voltage generated by the circular variable resistance unit. Similarly, in some embodiments, the specific position of the control stick being located at the inner rims of the circular resistance coils may be obtained by searching a first mapping table according to the loop voltage. The first mapping table records the positions of the control stick being located at the inner rims of the circular resistance coils corresponding to different loop voltages. After the specific position of the control stick is obtained, in step S820, an inclination of the projection device relative to the horizontal plane is calculated according to the specific position of the control stick. It is understood that, in some embodiments, the inclination of the projection device relative to the horizontal plane may be obtained by searching a second mapping table according to the loop voltage. The second mapping table records the inclinations of the projection device relative to the horizontal plane corresponding to different loop voltages. In step S830, a trapezoidal correction is performed for the projection device according to the inclination.

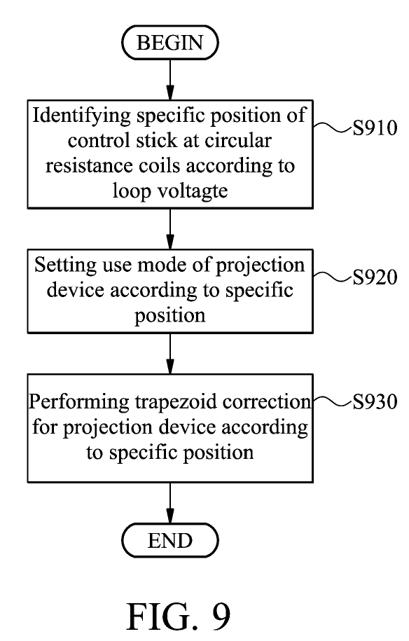

FIG. 9 is a flowchart of an embodiment of a picture correction method of the invention. In this embodiment, the use mode setting and trapezoidal correction are performed for the projection device, simultaneously.

In step S910, a specific position of the control stick being located at the inner rims of the circular resistance coils is identified according to the loop voltage generated by the circular variable resistance unit. Similarly, in some embodiments, the specific position of the control stick being located at the inner rims of the circular resistance coils may be obtained by searching a first mapping table according to the loop voltage. The first mapping table records the positions of the control stick being located at the inner rims of the circular resistance coils corresponding to different loop voltages. After the specific position of the control stick is obtained, in step S920, the use mode of the projection device is set as the table mode or the ceiling mode according to the specific position of the control stick. In some embodiments, when the specific position of the control stick is within a first range of the inner rims of the circular resistance coils, the use mode of the projection device is set as the table mode. When the position of the control stick is within a second range of the inner rims of the circular resistance coils, the use mode of the projection device is set as the ceiling mode. Then, in step S930, a trapezoidal correction is performed for the projection device according to the specific position of the control stick. In some embodiments, an inclination of the projection device relative to the horizontal plane may be calculated according to the specific position of the control stick, and the trapezoidal correction is performed according to the inclination.

Therefore, the picture correction system and method of the embodiments of the invention may automatically correct pictures for projection devices. The use mode setting and/or the trapezoidal correction may be automatically achieved without any manual operation.

Picture correction systems and methods for ballasts, or certain aspects or portions thereof, may take the form of a program code embodied in tangible media, such as floppy diskettes, CD-ROMS, hard drives, or any other machine-readable storage medium (i.e., executable instructions), wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A picture correction system adapted to a projection device, comprising:
a circular variable resistance unit, comprising:
at least two circular resistance coils, wherein one of the circular resistance coils is capable of receiving a voltage; and
a control stick, disposed on the inner rims of the circular resistance coils to be electrically connected with the circular resistance coils and capable of rolling along the inner rims of the circular resistance coils, wherein the circular variable resistance unit is capable of generating a loop voltage according to a position of the control stick being located at the inner rims of the circular resistance coils; and
a control unit, coupled to the circular variable resistance unit, and capable of receiving the loop voltage and performing a picture correction for the projection device according to the loop voltage.

2. The picture correction system of claim 1, wherein loop lengths of current flowing through the circular resistance coils are different according to different positions on the inner rims of the circular resistance coils where the control stick is located respectively, so that the circular variable resistance unit is capable of generating the different loop voltages.

3. The picture correction system of claim 2, wherein the circular resistance coils are arranged parallel to each other substantially.

4. The picture correction system of claim 1, wherein the control unit is further capable of searching a mapping table according to the loop voltage to obtain a specific position of the control stick being located at the inner rims of the circular resistance coils.

5. The picture correction system of claim 4, wherein when the specific position of the control stick is within a first range of the circular resistance coils, the control unit sets the projection device as a table mode, and when the specific position of the control stick is within a second range of the circular resistance coils, the control unit sets the projection device as a ceiling mode, and the first range and the second range are not overlapped to each other.

6. The picture correction system of claim 4, wherein the control unit is capable of performing a trapezoidal correction for the projection device according to the specific position of the control stick.

7. The picture correction system of claim 6, wherein the control unit is capable of calculating an inclination of the projection device relative to a horizontal plane according to the specific position, and performing the trapezoidal correction according to the inclination.

8. The picture correction system of claim 1, wherein the control unit is further capable of searching a mapping table according to the loop voltage to obtain an inclination of the projection device relative to a horizontal plane, and performing a trapezoidal correction for the projection device according to the inclination.

9. A picture correction method adapted to a projection device, comprising:
providing a circular variable resistance unit, wherein the circular variable resistance unit comprises at least two circular resistance coils and a control stick, the control stick is disposed on the inner rims of the circular resistance coils to be electrically connected with the circular resistance coils, and the control stick is capable of rolling along the inner rims of the circular resistance coils;
receiving a voltage by one of the circular resistance coils, and generating a loop voltage according to a position of the control stick being located at the inner rims of the circular resistance coils by the circular variable resistance unit; and
performing a picture correction for the projection device according to the loop voltage.

10. The picture correction method of claim 9, wherein loop lengths of current flowing through the circular resistance coils are different according to different positions on the inner rims of the circular resistance coils where the control stick is located respectively, so that the circular variable resistance unit generates different loop voltages.

11. The picture correction method of claim 10, wherein the circular resistance coils are arranged parallel to each other substantially.

12. The picture correction method of claim 9, wherein the step of performing the picture correction for the projection device according to the loop voltage comprises a step of searching a mapping table according to the loop voltage to obtain a specific position of the control stick being located at the inner rims of the circular resistance coils.

13. The picture correction method of claim 12, wherein the step of performing the picture correction for the projection device according to the loop voltage further comprises steps of:
when the specific position of the control stick is within a first range of the circular resistance coils, setting the projection device as a table mode; and
when the specific position of the control stick is within a second range of the circular resistance coils, setting the projection device as a ceiling mode, wherein the first range and the second range are not overlapped to each other.

14. The picture correction method of claim 12, wherein the step of performing the picture correction for the projection device according to the loop voltage further comprises a step of performing a trapezoidal correction for the projection device according to the specific position of the control stick.

15. The picture correction method of claim 14, wherein the step of performing the trapezoidal correction for the projection device according to the specific position of the control stick comprises steps of:
calculating an inclination of the projection device relative to a horizontal plane according to the specific position; and
performing the trapezoidal correction according to the inclination.

16. The picture correction method of claim 9, wherein the step of performing the picture correction for the projection device according to the loop voltage comprises steps of:
searching a mapping table according to the loop voltage to obtain an inclination of the projection device relative to a horizontal plane; and
performing a trapezoidal correction for the projection device according to the inclination.
